(19) United States
(12) Patent Application Publication
(10) Pub. No.: US 2005/0183024 A1
(43) Pub. Date: Aug. 18, 2005

(54) Architecture and method for integrating and presenting medical information

(76) Inventor: Henrik Andersson, Stockholm (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 10/507,229

(22) PCT Filed: Mar. 15, 2003
(86) PCT No.: PCT/US03/08225

Related U.S. Application Data
(60) Provisional application No. 60/365,975, filed on Mar. 19, 2002.

(51) Int. Cl. G06F 17/00; G06F 3/00

(52) U.S. Cl. 715/764; 715/843; 715/513; 705/3; 707/1

(57) ABSTRACT

The method is for navigating in a computer device containing medical information. A first medical module (12, 14, 16, 18, 20, 22, 24, 26, 28, 30) and a second medical module (12, 14, 16, 18, 20, 22, 24, 26, 28, 30) of a module menu are provided. The first medical module is different from the second medical module. A display (200) displays the module menu (204) and a bookmark activation device (228) for activating a bookmark module (290). The first medical module from the module menu is selected and a first information segment in the first medical module is marked as a first bookmark. The second medical module is selected and a second information segment in the second medical module is marked as a second bookmark. The first and second bookmarks are stored in the bookmark module (290). The bookmark activation device is triggered to activate and display the second bookmark module.

### TECHNICAL FIELD

The present invention relates to an architecture and method for integrating and presenting medical information.

### BACKGROUND AND SUMMARY OF INVENTION

Attempts have been made to improve the handling and presentation of complex medical information to the medical profession. However, the currently available method and systems are still quite cumbersome to use particularly when used in connection with handheld computers such as PDA devices. There is a need for a reliable and effective way of integrating and presenting medical information.

The present invention provides a solution to the above-outlined problems. More particularly, the method is for navigating in a computer device containing medical information. A first medical module and a second medical module of a module menu are provided. The first medical module is different from the second medical module. A display displays the module menu and a bookmark activation device for activating a bookmark module. The first medical module from the module menu is selected and a first information segment in the first medical module is marked as a first bookmark. The second medical module is selected and a second information segment in the second medical module is marked as a second bookmark. The first and second bookmarks are stored in the bookmark module. The bookmark activation device is triggered to activate and display the second bookmark module. Flash memory (track of latest entries module) and linking inside modules and between modules are important features also that all modules can be accessed at all times in the main menu and the flash and bookmarks modules

### BRIEF DESCRIPTION OF THE DRAWINGS

FIG. 1 is a schematic view of a national reference data interaction module assembly of the present invention;

FIG. 2 is a schematic view of a regional reference data interaction module assembly of the present invention;

FIG. 3 is a first sample display of a database mode of the present invention;

FIG. 4 is a second sample display of a database mode of the present invention;

FIG. 5 is a third sample display of a database mode of the present invention;

FIG. 6 is a fourth sample display of a database mode of the present invention;

FIG. 7 is a fifth sample display of a database mode of the present invention;

FIG. 8 is a sixth sample display of a database mode of the present invention; and

FIG. 9 is a seventh sample display of a database mode of the present invention.

### DETAILED DESCRIPTION

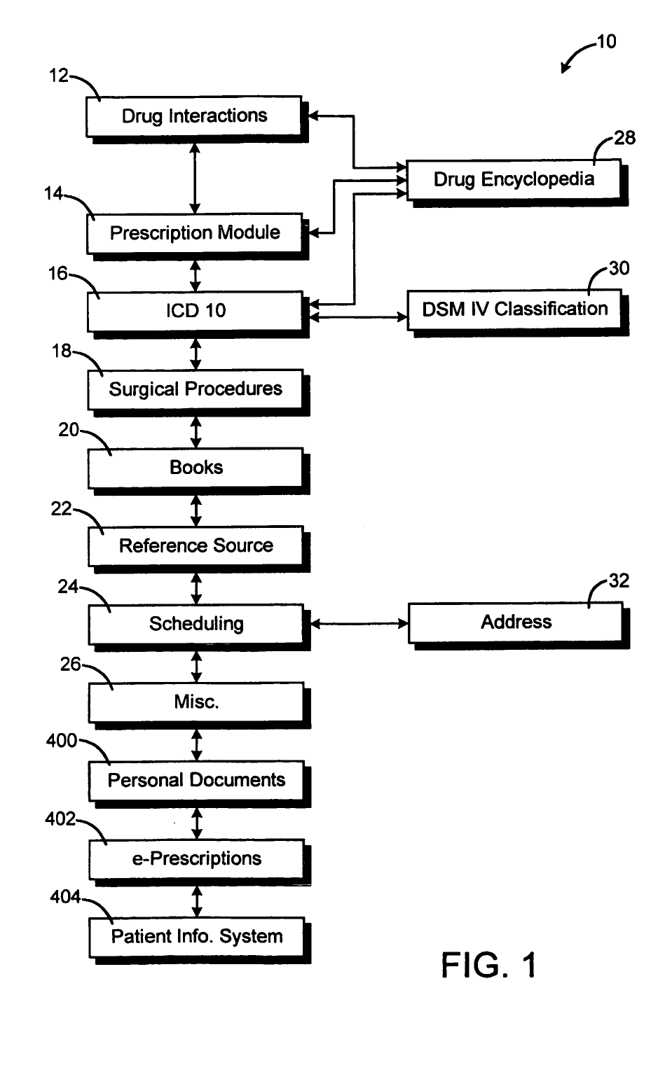

With reference to FIGS. 1-9, the present invention is a unique architecture and method for integrating and presenting medical information on a computer device such as a hand-held PDA computer devices or any other single task device to shorten the administrative work carried out by physicians and other medical professionals. The method also provides for improved patient security regarding drug information. The invention has a reference data component and a communication component. The reference data component may include national, regional and individual levels, as described below. An important aspect of the present invention is the selection of modules, how the modules interact with one another and the layout of the presentation of the module information.

FIG. 1 is a schematic view of a national reference data interaction module assembly 10 that has a drug interaction module 12, a prescription module 14, an ICD classification module 16, surgical procedures module 18, book modules 20, reference source module 22, scheduling module 24, and a miscellaneous module 26. The modules may work together. For example, the modules 12 and 14 may interact with one another. The modules 12, 14, 16 may also interact and link to a drug encyclopedia module 28 and the module 16 may interact with a DSM IV classification module 30. The scheduling module 24 may interact with an address module 32.

The encyclopedia module 28 may include short descriptions of the various drugs used. The module may be connected to databases such as FASS and PDR. When the interaction section of the drug 28 for a particular drug is insufficient, the user may activate the interaction module 12 to obtain more detailed information about how drugs may interact when a patient is using more than one drug. It may also be possible to search in the module 12. For example, if a patient is using five drugs, it is possible to search for all known interactions between the five drugs used by the patient.

The module 14 may be connected to a database that has standard or common prescriptions for the drugs listed in, for example, the FASS database. The module 14 may include standard text that may be used by the professional who is prescribing the drugs. The module 16 may include standard classification codes for each diagnosis, such as ICD 10 and ICD 9CM. More in depth diagnosis DSM codes for psychiatric diseases may be found in the module 30. However, psychiatric diagnoses may also have ICD codes. The module 30 may also be linked directly to the encyclopedia module 28.

The module 18 includes classification codes for surgical procedures. The book module 20 may include a plurality of medical reference books. Module 22 may include useful items such as calculators, tables for calorie requirements, body mass index calculations, body surface calculations and other formulas. The module 22 may also include laws and regulations that apply to the medical profession. The module may also have physiological reference values such as physiological and chemical reference values including normal values for chemical laboratories etc. The module 24 is an on-call schedule so that the physician can see who is on call during certain dates. The module 24 may interact with an address module 32 that includes, for example, the address and other vital contact information to the physicians in a certain area. The module 26 may also include miscellaneous information such as advertising and entertainment programs. The system may include additional modules such as personal documents module 400, e-prescription module 402 and patient information system module 404. Other modules may also be added as desired by the user.

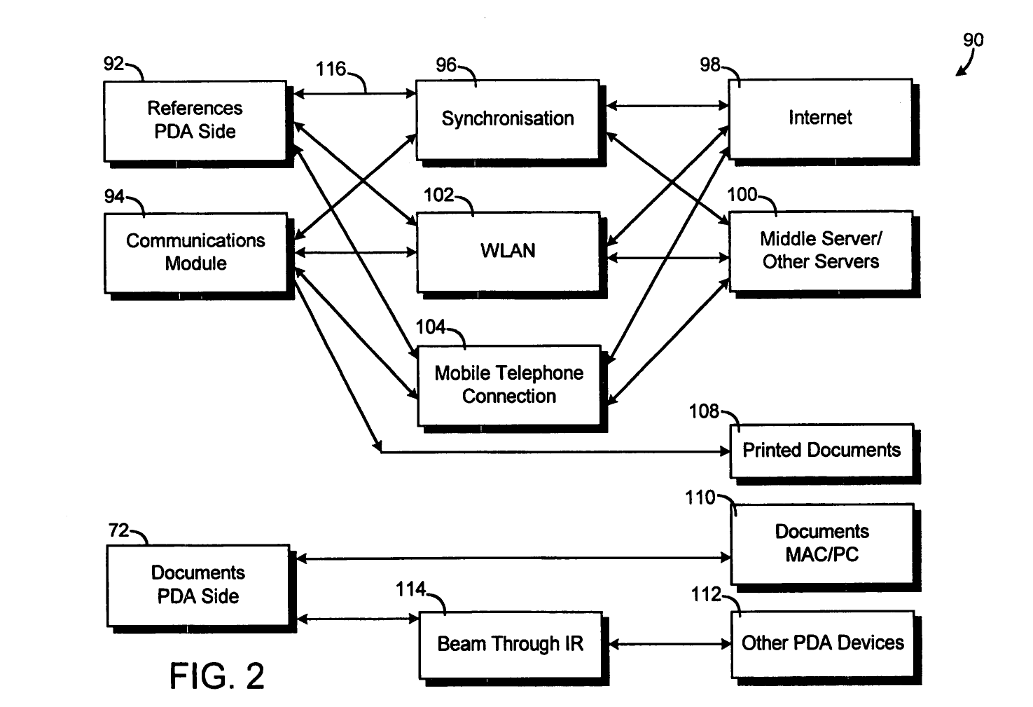

FIG. 2 is a schematic view of a regional reference data interaction module assembly 50 that may have a regional drug module 52 that includes information about regionally recommended drugs that may interact with the prescription module 14 of the national module assembly 10. If the physician prescribes a drug that is not regionally recommended a reminder may appear to prescribe the equivalent regionally recommended drug. The assembly 50 may also have a regional telephone directory module 54, regional treatment module 56, regional administrative routines module 58 and other regional information module 60 that may include miscellaneous regional information that may be useful to a professional in medicine. The module 54 may be focused on telephone numbers to regional medical facilities. The module 56 may include regional recommended treatment methods that may differ from treatment methods used in other regions. The module 58 may include information about regional administrative rules ranging from regional overtime reporting and payment and charging practices.

The individual reference data interaction module assembly includes a documentation module that may interact with Macintosh and PC documents. The module includes a conversion program that may be used to convert documents to a PDA file format so that hierarchic and non-hierarchic pictures and text may be transferred. The plug-in module supports formats such as word processing programs, graphics programs, HTML and other currently used formats so that outside text and pictures may be viewed in the architecture of the present invention. Of course, the module may be adapted to support other formats also. The end user is provided with a specific program that allows for hierarchic conversion from MS word and Excel with full support for pictures, text and tables. The hierarchic conversion is done by using headers H1, H2, H3 . . . H7. Each header size creates a new sublevel in the architecture of the handheld computer. The documents are fully integrated and allows for search, book marking, flash memory, notes and more.

The communication module assembly 90 describes how the communication between the platform of the present invention and outside sources may take place. The assembly may have a reference data assembly 92, a communication module 94 and the document module 72. The assembly may be used to add, for example, information to the prescription module and patient charts. The assembly may include the reference modules.

The communication module 94 may be used for many communication purposes such as communicating with a pharmacist to deliver prescriptions and registering certain illness in a registration program. The communication module may also be used to send survey information, provide side-effect reports, send medical certificates, provide feedback to drug companies, send information to billing department, provide information to research groups etc. The assembly may have a synchronization unit 96 for synchronizing information flows between the modules 92, 94 and PC/Mac and other types of documents on the Internet 98 and a middle server 100. The middle server may be used to communicate with, for example, pharmacies, health monitoring units, drug manufacturers, insurance companies and research facilities. The server 100 may also be used for surveys and computer journal systems. The unit 96 may communicate via the PDA cradle or use infrared and blue-tooth communication techniques. For example, when the user needs to send a prescription, by using the prescription module 14, the user simply places the PDA unit in the PDA cradle and press activate. A signal 116 is sent from the assembly 92 and includes the prescription module 14, to the synchronization unit 96 that synchronizes the signal and forwards a synchronized signal 118 to the middle server 100. The middle server 100 may then forward the prescription information to the pharmacist via any known communication media such as the Internet. The middle server 100 may also send back a confirmation signal to the user of the module assembly 92 to confirm that the signal has arrived to the correct pharmacist. The user may also use an infra red or blue tooth synchronization command on the PDA to send communication signals.

The assembly 90 may also be connected with a local area network unit 102 to enable correspondence between the modules 92, 94 and the Internet 98 and the middle server 100. The user may connect the PDA to the local area network 102 and send messages from the PDA via the network 102. For example, patient charts are often only available on the network unit 102 to privacy/security reasons. The assembly may further include a mobile phone connection unit 104 to facilitate the communication between the modules 92, 94 and the Internet 98 and the middle server 100.

If desired, any communication material may be printed by sending printing signals from the module 94 to a printing unit 108, such as using infra red, blue tooth and cradle communication techniques. As indicated earlier, the document companion module 72 may be used to interact, such as by placing the PDA in the PDA cradle, with PC/Mac and database documents 110 and with other PDA devices 112 via an infrared unit 114.

The assembly 90 may also be used to, for example, update the module assemblies 10, 50, 90. If the user needs to update one of the plug-in modules such as the encyclopedia module 28 of the assembly 10, the user may place the PDA in the PDA cradle and activate the updating function. The updating of the secure digital (SD) cards of the PDA may occur automatically or manually so that the module 28 receives updated information via one of the communication units 96, 102, 104. Of course, any other suitable card or storage technology may be used. Almost all information needed, except the patient charts, may be stored on the PDA. The patient charts cannot be stored, for legal and privacy reasons, and must be obtain via the network unit 102.

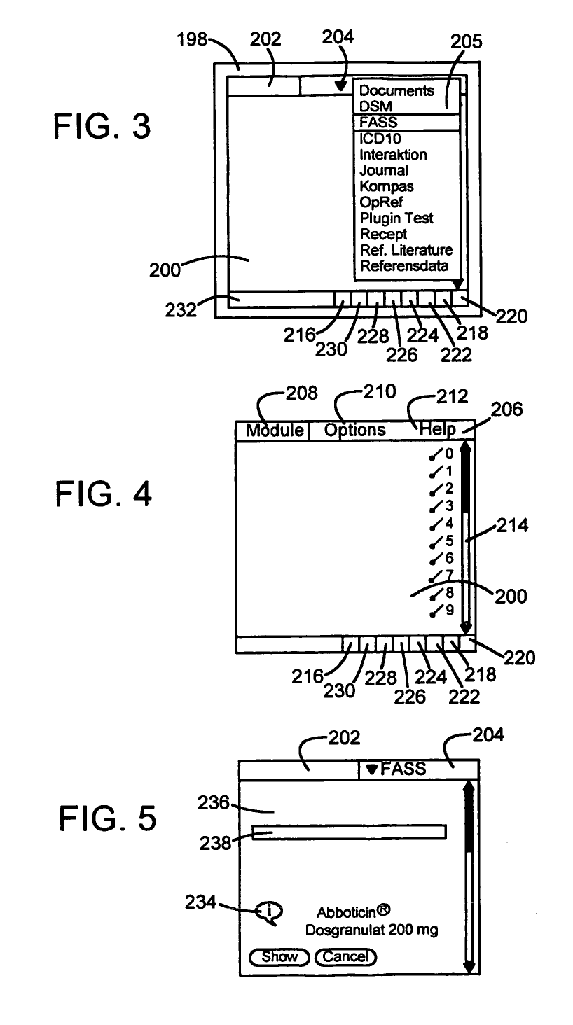

FIG. 3 is an example of a display 200 of a PDA unit 198 that has a doctor companion tab 202 and a module tab or arrow 204 at an upper end of the display 200. By activating the tab 204, the display shows a drop menu that lists all the modules available on the PDA 198, such as the modules 12, 14, 16 etc. described in FIG. 1. The user may add and delete modules from the unit 198, as desired, since each module is a plug-in module.

For illustrative purposes, the user has selected the module 28, associated with the FASS database, so that a long list of drugs is shown. By pressing on the tab 204 again a new module may be displayed. It should be noted that the user may change to another module at any time by pressing the tab 204 with a cursor or electronic pen.

By activating the tab 202, the display 200 displays a sub-menu 206 including a unit 208, alternative tab 210 and help tab 212, as shown in FIG. 4. While in the mode of the unit 208, the display 200 displays a menu 212 of sub-groups of the module 28 such as ATC codes, pregnancy and breast feeding issues related to the drugs listed in the FASS database. On the right side of the menu 212 is a short-cut list 214 of quick commands to activate each sub-group by pressing, for example, the short cut command “/4” to a sub-menu for pregnancy and breast feeding. The alternative tab 210 may be used as an alternative to the bar 216 because the commands such as search, back arrow, forward arrow, home etc. are shown in the tab 210.

All the main displays have the common tool bar 216 at the lower end of the display. The bar 216 may have a house button 218 with a right arrow 220 and a left arrow 222 on each side of the button 218. By activating the button 218, the user may go back to the starting position or starting menu of each module. The arrows 220, 222 permit the user to go forward or backward within a module. For example, if the user has activated one of the drugs listed in the menu 200 and needs to go back to the initial menu, the user may click on the back arrow 222. The arrows 220, 222 may also be used to move between different plug-in modules such as between the module 28 and the drug interaction module 12 and then back to the module 28. The arrows have functions that are similar to arrow commands used by the Internet browser.

The tool bar 216 also has a flash button 224, notes button 226 and bookmarks button 228. The button 224 may be used as a quick memory that saves the first (n) number of the latest searches in a chronological order for each plug-in module. When search number (n+1) is conducted, the first search will disappear from the short-term memory list. The button 226 permits the user to make personal notes in connection with a search. The notes are saved and available next time the user activates the particular plug-in module. The button 228 permits the user to create a personal quick register that may include a certain number of items. The bar 216 also has a search command 230 that starts the search engines in the particular plug-in module that is being used. The bar 216 also has a clock 232 and by clicking on the clock, a timer is displayed. The timer has a stopwatch and a unique heart rate calculator. Here the user can simply tap the buttons on the handheld computer or the screen directly, while doing this a flashing heart will appear on the screen and the tapping frequency will be displayed in numbers. This instrument allows the user to check the heart rate/pulse of the patient without having to rely on a watch. The help button 212 may include manuals for each plug-in module to aid the user in how to operate the system.

FIG. 5 is an illustrative view of a display 234 that shows details of a drug listed in the display 200 of FIG. 3. The user may select a drug from the display 200 and activate it to show details of the selected drug, as shown in the display 234. In other words, the display may show information at a more detailed level that is below the list of drugs shown in the display 200.

Because the width of a typical PDA display such as the display 234 is often shorter than the length of a typical sentence, the whole sentence cannot be shown in the display. However, the user may mark or tap a line 236 with an electronic pen 238 and then hold the pen on the line and the display will scroll to the right to show the whole sentence.

If the user wants to go down one level, the user merely taps an item in the display. If the user wants to view an entire sentence, when the sentence is longer than the width of the display, the user taps and holds the pen on the selected line the full text will then appear in a dialogue box. When tap and hold is applied to pictures a zoom functionality appears for the selected part if the picture, the zoom part follows when the pen moves around the screen. The user may also switch module by clicking on the tab 204 to display a menu of another module, such as the ICD module 16, as shown in FIG. 1. The same tap and hold commands apply to the new module and other modules.

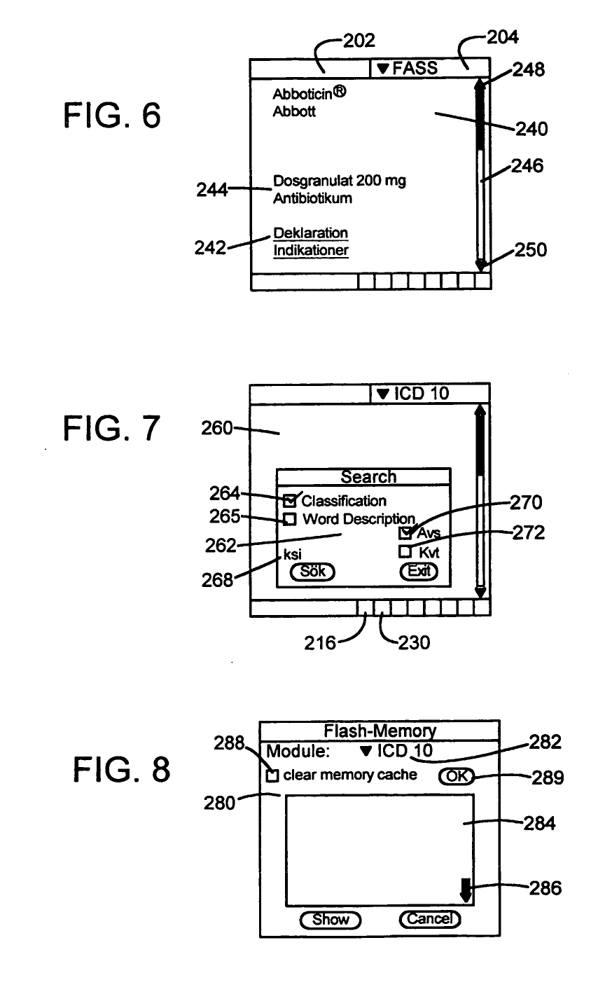

FIG. 6 is an illustrative example of a sub-menu 240 including underlined text that functions as links 242. The menu 240 also includes free text 244 and the user may put the pen 238 directly on the text 244, where there is no link text 242, and pull the text in a desired direction with the pen 238. The user may also activate a scroll bar 246 on the right side of the menu 240 and pull a marker up and down to correspondingly move the text up and down. The user may also click with the pen 238 on arrows 248, 250 to move within the text 244. When clicking on a link, the information, such as text, pictures and tables, opens and expands. The link is visible on top and when the user scrolls the next link appears at the bottom of the information. By clicking on the back arrow the user is taken to the non-expanded start-point.

FIG. 7 is a schematic illustrative view 260 of a search pop-up window 262 that may be shown by activating the search command 230 in the tool bar 216. The menu in the window 262 is customized to the particular module that is in use. For example, when the module 28 is used, the window 262 enables the user to search for a drug by the name of the generic substance of the drug or by the trademark of the drug. When the module 12 is used, the user may search for the drug trademark, the generic name or an interaction search command. The interaction search command is a multiple interaction search command that enables a search for many drug names to determine the interactive effect therebetween. When the module 16 is used, the user may search by classification code 264 or word description 266. The search words may be entered on a line 268 in the window 262 and the user may select the level of the word search by marking a category box 270 or a section box 272. By marking the box 272, the user may obtain all diagnosis available for a drug.

FIG. 8 shows a flash memory display 280 that lists the latest searches for a particular module. The user may change the module by pressing the tab 282 to list the latest search commands for a different module. The user may scroll down the list 284 by pressing an arrow 286 or by dragging the text down with the electronic pen. As indicated above, the display 280 may be designed so that when the display is full and the user would like to add one more search command, the display 280 will delete the oldest or first search command. The cache memory may be cleared by marking a box 288 and press an okay button 289.

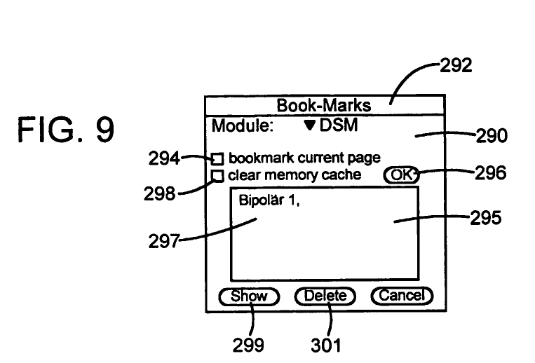

FIG. 9 shows a bookmark view/module 290 that the user may use to bookmark favorite information in each module 12-32, as shown in FIG. 1. The module 290 may be displayed by activating the bookmark 228 so that the bookmarks for the particular module that has been selected are displayed. An important feature of the method of the present invention is that the user may jump directly to the bookmarks of other modules without having to restart each module and then find the bookmarks. The user may change module by clicking on a tab 292 so that the user may, for example, switch from the module 12 to the module 16 while the user is within the bookmark module 292. When an interesting page or information segment 295 has been found, the user may bookmark the page by marking a bookmark box 294 and an okay button 296. The user may clear the memory cache by marking a clearance box 298 and pressing the button 296. The user may display previously selected bookmarks from other module by activating the tab 292 and selecting another module to display a list 297 of the bookmarks 295 for that other selected module. The user may then select the bookmark 295 of interest from the list 297 and press show 299 to display the entire information segment of the bookmark 295. The bookmark 295 and other bookmarks may be deleted by pressing a delete button 301.

It is also possible to bookmark one segment many times so that more than one module may have the same bookmark.

It may also be possible to add a survey module that may be used for national, regional as well as local/individual content applications. The user may use the module to fill out various surveys/feedback documents such as studies of disease, reports on side effects of drugs etc. The documents may be synchronized over mobile telephone, cradle, infrared, bluetooth and WLAN directly over to an xml compatible database or any other suitable database. The survey module may be customized and converted to PDA format by the user in the computer by using a survey companion program and then be transferred to the hand held computer. The user may then fill out the survey on the hand held computer and synchronize it over to an xml based or any other type of database for further processing.

While the present invention has been described in accordance with preferred compositions and embodiments, it is to be understood that certain substitutions and alterations may be made thereto without departing from the spirit and scope of the following claims.

1. A method for navigating in a computer device containing medical information, comprising:
providing a first medical module (12, 14, 16, 18, 20, 22, 24, 26, 28, 30) and a second medical module (12, 14, 16, 18, 20, 22, 24, 26, 28, 30) of a module menu, the first medical module being different from the second medical module:
providing a display (200) displaying the module menu (204) and a bookmark activation device (228) for activating a bookmark modules (290);
selecting the first medical module from the module menu and marking a first information segment in the first medical module as a first bookmark;
selecting the second medical module and marking a second information segment in the second medical module as a second bookmark, the first and second bookmarks being stored in the bookmark module (290); and
activating the bookmark activation device to activate and display the second bookmark module.

2. The method according to claim 1 wherein the method further comprises activating a module menu tab 292 in the bookmark module (290) and selecting the first medical module to trigger the bookmark module to display the first bookmark.

3. The method according to claim 1 wherein the method further comprises, selecting the second medical module so that the bookmark module displays the second bookmark.

4. The method according to claim 1 wherein the method further comprises activating a flash memory (224) to display a latest search command.

5. The method according to claim 1 wherein the method further comprises associating the second medical module to the first bookmark while the first bookmark is associated with the first medical module.

6. The method according to claim 1 wherein the method further comprises clearing a memory cache (298) containing all bookmarks.

7. The method according to claim 1 wherein the method further comprises activating a back arrow (222).

8. The method according to claim 1 wherein the method further comprises activating a forward arrow (220).

9. The method according to claim 1 wherein the method further comprises using a word processing header H1, . . . H7 to create hierarchical conversion of documents.

10. The method according to claim 1 wherein the method further comprises using a link to move within a module and move to another module and using an expanding link to expand a text portion between existing links.
